(19) United States
(12) Patent Application Publication
(10) Pub. No.: US 2004/0184071 A1
(43) Pub. Date: Sep. 23, 2004

(54) Pluggable pre-parser for PJL and PS for extracting print job relates header information from a running stream

(76) Inventors: Man M. Garg, Cerritos, CA (US); Jason Wei, Garden Grove, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/391,841

(22) Filed: Mar. 19, 2003

(51) Int. Cl. G06F 3/12; G06F 15/00

(52) U.S. Cl. 358/1.15; 710/52; 710/39; 710/40; 718/103; 358/1.16

(57) ABSTRACT

A system and method that uses a pluggable preprocessor for monitoring a running job data stream that looks for header information to determine the appropriate queue for the job data stream. The data stream is then routed to the appropriate queue. The header information typically comprises a job name, an owner, and routing information. Thus, a print job will appear in the appropriate queue immediately while it is still being spooled. A job scheduler can trigger processing of the job when the processor is available and the job is ready for processing. This facilitates the handling of many jobs simultaneously segregated into their respective priority queues as soon as the clients send the jobs. Processing may then be serialized based on the processor load and job scheduling logic.

### COPYRIGHT OR MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

The present invention is related generally to print job processing, and more specifically to preprocessing an image stream.

Embedded print systems are typically connected to networks for obtaining print streams. The system then processes the stream by obtaining header information and performing image manipulation, and then sends the processed data to the printer in a manner suggested by the header information in the stream. Currently, extracting header data and image processing is a single step process which is a very processor intensive task. the problem with this approach is that the header information is not available until the image data is processed. Because print drivers are providing more features such as scheduled printing, private printing, printing to e-mail, etc., it is useful to obtain the header information before processing the job data so that the job and be routed to the appropriate queue. For example, if a job is scheduled to be printed at a later time, the image processing can be delayed until print time, allowing the processor to process jobs currently being printed. This prevents latency in the printing system. Also the job will appear to be waiting in the correct queue as soon as the job is created and is being spooled instead of waiting for its turn to get processed before getting sent to the right queue.

Referring to FIG. 1, there is shown a typical process 100 currently used. the process 100 starts at step 102 by a client sending a job. As shown by step 104, the job is then spooled. At step 106 the spooled job data is stored in either an input queue, temporary storage area or a spooler storage area. At this time the job will not show as ready to print or scheduled or waiting for user input (private queue). At step 108 processing of the job data begins. At step 100 the job data is processed and routed to the appropriate queue, which may be either the Private queue 110a, the Scheduled queue 110b, the Urgent queue 110c, or the Normal queue 110d. The job waits in the appropriate queue until step 112 when an output device is ready to receive the job. Then as shown in step 114, the print job is routed from the queue, either 110a, 110b, 110c, or 110d and sent to the output device wherein the output is produced.

As seen in FIG. 1, the job data has to be processed (step 108) prior to placing the job in the appropriate queue (step 110). This is because the parameters to determine the job queue are contained in the job data. The prior art process is a time consuming process that holds jobs in a temporary queue until the processing step (108) is completed. This can cause latency, especially when multiple jobs arrive from different clients at the same time. This can delay the time that a job becomes visible in the proper queue. Another problem with the prior art approach is that the job processing can cause multiple processes to be created at the same time which can overload the processor.

Thus what is needed is a method for routing data streams to the correct queue without introducing any significant delay in the spooling process.

### BRIEF SUMMARY OF THE INVENTION

In view of the aforementioned needs, the invention contemplates splitting the processing of job data into two distinct steps of extracting header information and image processing. Currently the extracting header and image processing is a single step process which is a very processor intensive tasks. The present invention contemplates parsing the header of a running stream of data while the job is still being spooled without causing any significant delay in the spooling process One aspect of the present invention contemplates a system and method that uses a preprocessor for monitoring a running job data stream that looks for header information to determine the appropriate queue for the job data stream. The data stream is then routed to the appropriate queue.

In a preferred embodiment the data stream is a spooler. The header information typically comprises a job name, an owner, and routing information. The preprocessor allows image data to pass through.

One aspect of the present invention is that a print job will appear in the appropriate queue immediately while it is still being spooled. A job scheduler can trigger processing of the job when the processor is available and the job is ready for processing. This facilitates the handling of many jobs simultaneously segregated into their respective priority queues as soon as the clients send the jobs. Processing may then be serialized based on the processor load and job scheduling logic.

In the preferred embodiment, the preprocessor is designed to be pluggable so that it can be attached to any running stream, such as a spooler. The preprocessor may be internally implemented as a state-machine, which recognizes the state of the data in the stream and determines what type of data is being received, for example header start, header data, image data, etc. If the received data is header data, the preprocessor parses the data and returns the job parameters for the stream. Image data is passed through without any processing.

Still other objects of the present invention will become readily apparent to those skilled in this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention. In the drawings:

FIG. 1 is a block diagram illustrating the steps of a typical prior art process for processing a data stream; and

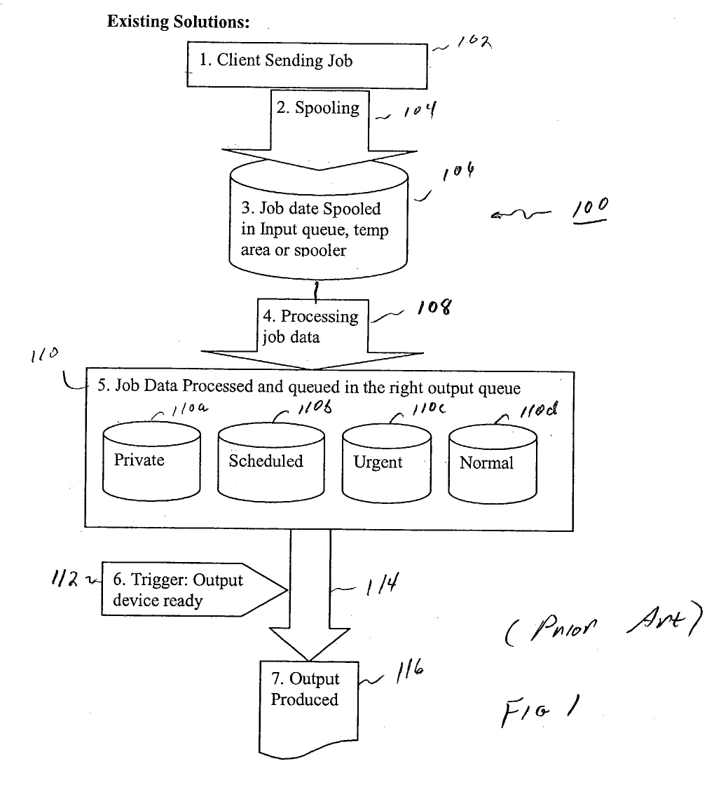

FIG. 2 is a block diagram illustrating the steps of the preferred embodiment of the present invention for processing a data stream.

### DETAILED DESCRIPTION OF INVENTION

Throughout this description, the preferred embodiment and examples shown should be considered as exemplars, rather than limitations, of the present invention.

One aspect of the present invention herein is directed to methods using a preprocessing for handling data streams. Other aspects of the invention are directed to apparatuses and computer-readable medium of instructions that utilize the method.

The method of processing a data stream comprises the steps of monitoring the data stream, determining an appropriate queue for the data stream, determining other header information about the job like sender, jobname; and routing the data stream to the appropriate queue.

There are many other features, aspects and embodiments which may accompany the method. For example the data stream may be a print spooler. The monitoring step may further comprise extracting header information. The header information containing a job name, an owner name, and/or comprises routing information. While the monitoring step would extract header information, it would allow image data to pass through.

Once the image stream has been routed to the appropriate queue, it waits at the queue until a processor is ready to process the image data. The queue may be selected from the group consisting of a private queue, a scheduled queue, an urgent queue, and a normal queue. After the image data is processed, it is sent to an output device wherein an output is produced.

In a preferred embodiment, the method comprises monitoring an image data stream being routed to a spooler, parsing header information from the image data stream, determining an appropriate queue for the image data stream, routing the image data stream to the appropriate queue, waiting for an available processor, processing the image data stream at the appropriate queue; and sending the image data stream to an output device.

The present invention contemplates a thing on the wire processor that monitors a running job data stream and looks for the header information necessary to determine the proper queue for the job, and routing the job to the proper queue. The basic job information is attached to the job when the job is in the queue. This eliminates the need of having to perform job data processing and without introducing any significant delay in the spooling process. The present invention enables the job to appear in the correct queue immediately while it is still being spooled. A job scheduler can trigger the processing of the job when a processor is available and the job is ready for processing. This allows many jobs to be simultaneously segregated into their respective priority queues as soon as clients send the jobs. Processing of the jobs may then be serialized based on the processor load.

The parser is designed to be pluggable so that it can be attached to any running stream, such as a print stream. It is internally implemented as a state-machine, which recognizes the state of the data in the stream and determines what type of data is being received, for example header start, header data, image data, etc. If the data being received is header data, the stream is parsed, if the data received is image data it is allowed to pass through. During parsing, the parser returns job parameters received from the stream which can be utilized by the print system to route the job to the correct priority queue.

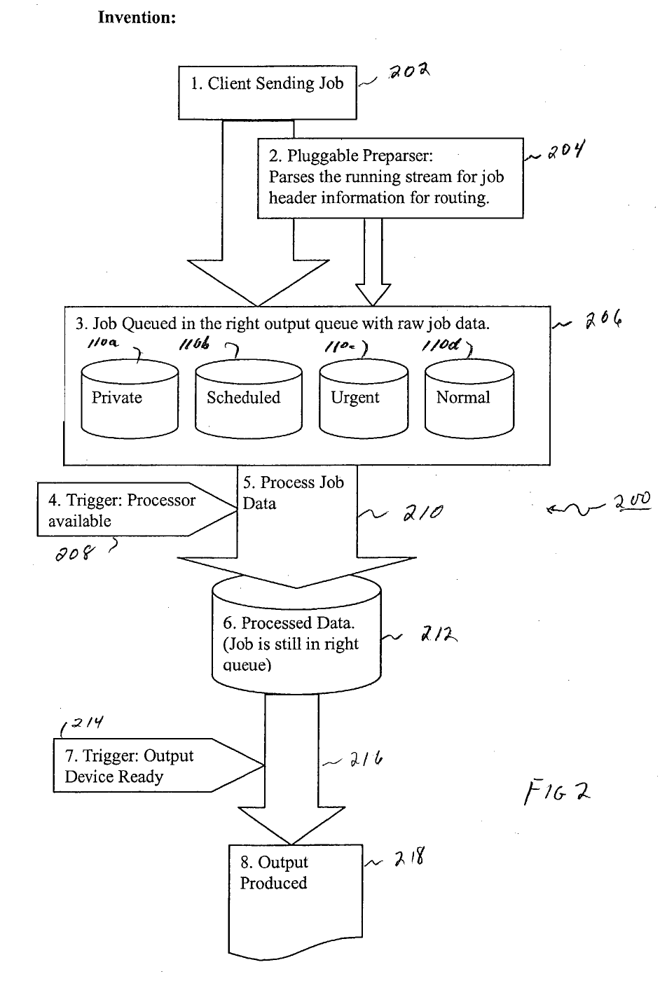

Referring now to FIG. 2, there is shown a method 200 contemplated by the present invention. The process begins at step 200 when a client sends a job. At step 204 the pluggable preparser evesdrops on the stream and parses the running stream for job header information to determine the appropriate routing of the stream. The pluggable preparser may be implemented in hardware, software, or a combination thereof. After parsing the stream, as shown in step 206 the job is queued into the appropriate output queue with the job data. As shown in FIG. 2, the job may be routed to a private queue 110a, a scheduled queue 110b, an urgent queue 110c, or a normal queue 110d. Other queues may also be used with the present invention. At step 208, the job waits until a processor becomes available, then as shown at step 210 the job is processed, and the processed data remains in the appropriate queue as shown in step 212. The job waits as shown by step 214 until an output device is ready, wherein as shown in step 216 it is forwarded to the output device, and as shown at step 218 an output is produced.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of the ordinary skill in the art to utilize the invention in various embodiments and with various modifications as are suited to the particular use contemplated. All such modifications and variations are within the scope of the invention as determined by the appended claims when interpreted in accordance to the breadth to which they are fairly, legally and equitably entitled.

What is claimed is:

1. A method of processing a data stream, the steps comprising
monitoring the data stream;
determining an appropriate queue for the data stream; and
routing the data stream to the appropriate queue.

2. The method of claim 1 wherein the data stream is a spooler.

3. The method of claim 1, the monitoring step further comprising extracting header information.

4. The method of claim 3 wherein the header information comprises a job name.

5. The method of claim 3 wherein the header information comprises an owner name.

6. The method of claim 3 wherein the header information comprises routing information.

7. The method of claim 1, the monitoring step further comprising passing through image data.

8. The method of claim 1 further comprising waiting for a processor and processing image data.

9. The method of claim 8 further comprising waiting for an available output device, and sending the image data to the available output device.

10. The method of claim 1 wherein the queue is selected from the group consisting of a private queue, a scheduled queue, an urgent queue, and a normal queue.

11. A method of processing job data for an image output device, the steps comprising:
monitoring an image data stream being routed to a spooler;
parsing header information from the image data stream;
determining an appropriate queue for the image data stream;
routing the image data stream to the appropriate queue;
waiting for an available processor;
processing the image data stream at the appropriate queue; and
sending the image data stream to an output device.

12. The method of claim 11 wherein the image data stream is routed to a private print queue, the steps further comprising associating a private print password with the image data.

13. The method of claim 11 wherein the image data stream is a first image data stream and is scheduled to be printed at a scheduled time, the routing step further comprising routing the image data stream to a scheduled print queue, the steps further comprising processing a second image data stream until the scheduled time of the first image data stream.

14. The method of claim 11 wherein the image data stream is routed to an urgent print queue, the processing step further comprising processing the urgent queue until the urgent queue is empty before processing any other queue.

15. The method of claim 11, the parsing step further comprising obtaining priority data for the image data stream and the processing step processing the image data stream according to the priority data.

16. A computer-readable medium of instructions, comprising
means adapted to monitor the data stream;
means adapted to determine an appropriate queue for the data stream; and
means adapted to route the data stream to the appropriate queue.

17. The computer-readable medium of instructions of claim 16 wherein the data stream is a spooler.

18. The computer-readable medium of instructions of claim 16, the means adapted to monitor further comprises means adapted to extract header information.

19. The computer-readable medium of instructions of claim 18 wherein the header information comprises a job name.

20. The computer-readable medium of instructions of claim 18 wherein the header information comprises an owner name.

21. The computer-readable medium of instructions of claim 18 wherein the header information comprises routing information.

22. The computer-readable medium of instructions of claim 16, the means adapted to monitor further comprising means adapted to pass through image data.

23. The computer-readable medium of instructions of claim 16 further comprising means adapted to wait for a processor and means adapted to process image data.

24. The computer-readable medium of instructions of claim 23 further comprising means adapted to wait for an available output device, and means adapted to send the image data to the available output device.

25. The computer-readable medium of instructions of claim 16 wherein the queue is selected from the group consisting of a private queue, a scheduled queue, an urgent queue, and a normal queue.

26. A computer-readable medium of instructions, comprising:
means adapted to monitor an image data stream being routed to a spooler;
means adapted to parse header information from the image data stream;
means adapted to determine an appropriate queue for the image data stream;
means adapted to route the image data stream to the appropriate queue;
means adapted to wait for an available processor;
means adapted to process the image data stream at the appropriate queue; and
means adapted to send the image data stream to an output device.

27. The computer-readable medium of instructions of claim 26 wherein the image data stream is routed to a private print queue, the computer-readable medium of instructions further comprising means adapted to associate a private print password with the image data.

28. The computer-readable medium of instructions of claim 26 wherein the image data stream is a first image data stream and is scheduled to be printed at a scheduled time, the means adapted to route comprising means adapted to route the image data stream to a scheduled print queue, the computer-readable medium of instructions further comprising means adapted to process a second image data stream until the scheduled time of the first image data stream.

29. The computer-readable medium of instructions of claim 26 wherein the image data stream is routed to an urgent print queue, the means adapted to process further comprising means adapted to process the urgent queue until the urgent queue is empty before processing any other queue.

30. The computer-readable medium of instructions of claim 26, the means adapted to parse step further comprising means adapted to obtain priority data for the image data stream and the means adapted to process further comprising means adapted to process the image data stream according to the priority data.

31. An apparatus for processing an image stream comprising
a preprocessor, the preprocessor comprising
means adapted to monitor the data stream;
means adapted to determine an appropriate queue for the data stream; and
means adapted to route the data stream to the appropriate queue.

32. The apparatus of claim 31 wherein the data stream is a spooler.

33. The apparatus of claim 31, the means adapted to monitor further comprising means adapted to extract header information.

34. The apparatus of claim 33 wherein the header information comprises a job name.

35. The apparatus of claim 33 wherein the header information comprises an owner name.

36. The apparatus of claim 33 wherein the header information comprises routing information.

37. The apparatus of claim 31, the means adapted to monitor step further comprising means adapted to pass through image data.

38. The apparatus of claim 31 further comprising means adapted to wait for a processor and means adapted to process image data.

39. The apparatus of claim 38 further comprising means adapted to wait for an available output device, and means adapted to send the image data to the available output device.

40. The apparatus of claim 31 wherein the queue is selected from the group consisting of a private queue, a scheduled queue, an urgent queue, and a normal queue.

41. An apparatus for processing job data for an image output device, comprising:
a preprocessor, the preprocessor comprising
means adapted to monitor an image data stream being routed to a spooler,
means adapted to parse header information from the image data stream,
means adapted to determine an appropriate queue for the image data stream, and
means adapted to route the image data stream to the appropriate queue;
means adapted to wait for an available processor;
means adapted to process the image data stream at the appropriate queue; and
means adapted to send the image data stream to an output device.

42. The apparatus of claim 41 wherein the image data stream is routed to a private print queue, the preprocessor further comprising means adapted to associate a private print password with the image data.

43. The apparatus of claim 41 wherein the image data stream is a first image data stream and is scheduled to be printed at a scheduled time, the means adapted to route further comprising means adapted to rout the image data stream to a scheduled print queue, the means adapted to process the image further comprising means adapted to process a second image data stream until the scheduled time of the first image data stream.

44. The apparatus of claim 41 wherein the image data stream is routed to an urgent print queue, the means adapted to process further comprising means adapted to process the urgent queue until the urgent queue is empty before processing any other queue.

45. The apparatus of claim 41, the means adapted to parse step further comprising means adapted to obtaining priority data for the image data stream and the means adapted to process further comprising means adapted to processing the image data stream according to the priority data.
